(19) United States
(12) Patent Application Publication
(10) Pub. No.: US 2007/0232281 A1
(43) Pub. Date: Oct. 4, 2007

(54) WIRELESS COMMUNICATION DEVICE AND METHOD OF SETTING INDIVIDUAL INFORMATION THEREIN

(75) Inventors: Yuko Nakai, Tokyo (JP); Fumio Anekoji, Ninomiya-Machi (JP); Koichi Matsuo, Yokohama-shi (JP)

Correspondence Address: FREESCALE SEMICONDUCTOR, INC.;LAW DEPARTMENT, 7700 WEST PARMER LANE MD:TX32/PL02, AUSTIN, TX, 78729, US

(73) Assignee: Freescale Semiconductor, Inc., Austin, TX (US)

(21) Appl. No.: 11/686,943

(22) Filed: Mar. 15, 2007

(30) Foreign Application Priority Data
Mar. 16, 2006 (JP) 2006-72909

(51) Int. Cl. H04Q 7/38; G08B 1/08

(52) U.S. Cl. 455/414.1; 340/539.21

(57) ABSTRACT

A wireless communication device, an individual information writing device, and an individual information setting method that efficiently write individual information, such as a unique identifier used for wireless communication, to each wireless device. An address writing device transmits a unique address setting communication request. A wireless device has a control unit that checks whether a provisional address is set in a unique address memory. When a provisional address is set, the control unit measures the signal intensity of a received unique address setting communication request with an electric field intensity measuring unit. When the electric field intensity is greater than a threshold value stored in an address setting condition memory and thereby satisfies an address setting condition, the wireless device performs a process for setting a unique address and then transmits a completion notification to the address writing device.

### BACKGROUND OF THE INVENTION

The present invention relates to wireless communication technology, and more particularly, to a wireless communication device, an individual information writing device, and an individual information setting method that are used to register individual information.

To identify nodes in a network, a physical address, which is unique to each piece of hardware, is allocated to a network device such as a LAN card. A media access control (MAC) address is set as such a physical address. A MAC address includes an organizationally unique identifier (OUI), which the Institute of Electrical and Electronic Engineers (IEEE) manages and allocates to each vendor (manufacturer), and lower rank bits set by each vendor in order to have uniqueness.

MAC addresses are applied to wireless communication technology (refer, for example, to Japanese Laid-Open Patent Publication No. 2003-018234, page 1). From the viewpoint of high speed and convenience, MAC addresses are nowadays applied to various types of wireless technology. Short-distance wireless communication using such wireless communication technology enables communication within a predetermined range (within 100 meters). In such a case, when wireless communication starts, the wireless device of the communication partner is located. To locate the wireless device, the MAC address allocated to a network card is used. Such a network device stores a communication program for performing a communication process and a MAC address uniquely allocated to the device.

When mass-producing such a network device, a common communication program is written to a memory in each network device. An address (e.g., MAC address) uniquely allocated to each network device is also written to the memory. The writing of the MAC address is performed by connecting each network device to a data writing device via a cable, such as a serial interface.

However, the connection of each network device to a cable is burdensome. Further, the arrangement of a data writing external interface, which is normally not used, is inefficient and disadvantageous from structural aspects.

Remote controllers used in houses and offices perform infrared communication having strong directivity. Therefore, the application of a short-distance wireless communication standard, which has low power consumption, to such remote controllers is now being considered. In this case, the setting of individual information must be performed separately for the remote controller and the subject device controlled by the remote controller. Accordingly, it is required that the writing of the individual information be easily and efficiently performed.

### SUMMARY OF THE INVENTION

The present invention provides a wireless communication device, an individual information writing device, and an individual information setting method that efficiently write individual information, such as a unique identifier used for wireless communication, to each wireless device.

One aspect of the present invention is a wireless communication device including an individual information storage unit for storing individual information used for wireless communication. A communication device performs wireless communication using the individual information stored in the individual information storage unit. A radio wave intensity measurement unit measures electric field intensity of a wireless radio wave received from a communication partner. A controller performs a process for writing the individual information. The controller checks whether unique individual information used for wireless communication with the communication partner is set in the individual information storage unit and performs a process for writing individual information acquired from the communication partner to the individual information storage unit when the electric field intensity of the wireless radio wave from the communication partner measured by the radio wave intensity measurement unit is greater than or equal to a reference value.

A further aspect of the present invention is a wireless communication device including an individual information storage unit for storing individual information used for wireless communication. The communication device performs wireless communication using the individual information stored in the individual information storage unit. A radio wave intensity measurement unit measures electric field intensity of a wireless signal. A controller performs a process for writing the individual information. The controller checks whether unique individual information used for wireless communication is set in the individual information storage unit when receiving a wireless signal related to an individual information setting request including unique individual information from an individual information writing device. The radio wave intensity measurement unit measures the electric field intensity of the wireless signal for the individual information setting request received from the individual information writing device. The controller performs a process for writing unique individual information acquired from the individual information writing device to the individual information storage unit when the electric field intensity is greater than or equal to a reference value.

Another aspect of the present invention is an individual information writing device for performing a process for writing individual information. The individual information writing device includes an individual information storage unit for storing individual information used for wireless communication. A communication device performs wireless communication using the individual information stored in the individual information storage unit. A radio wave intensity measurement unit measures electric field intensity of a wireless signal. The individual information writing device transmits a wireless signal related to an individual information setting request including unique individual information to a wireless device, locates individual information included in a response from the wireless device, and compares the individual information with predetermined provisional individual information. The radio wave intensity measurement unit measures the electric field intensity of a wireless signal related to the response. The controller performs a process for writing unique individual information to the individual information storage unit when the individual information included in the response is identical to the provisional individual information and the electric field intensity is greater than or equal to a reference value.

A further aspect of the present invention is a method for setting individual information of a wireless device using an individual information storage unit for storing individual information used for wireless communication, a communication device for performing wireless communication using the individual information stored in the individual information storage unit, a radio wave intensity measuring unit for measuring electric field intensity of a wireless signal for a response, and an individual information writing device for performing a process for writing individual information. The method includes transmitting a wireless signal related to an individual information setting request including unique individual information to a wireless device with the individual information writing device, locating individual information included in a response from the wireless device with the individual information writing device, comparing the individual information and predetermined provisional individual information with the individual information writing device, measuring the electric field intensity of a wireless signal of the response with the radio wave intensity measurement unit, and performing a process for writing unique individual information to the individual information storage unit when the individual information included in the response is identical to the provisional individual information and the electric field intensity is greater than or equal to a reference value.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a flowchart showing processing procedures according to a preferred embodiment of the present invention;

FIG. 2 is a block diagram showing a system of a preferred embodiment of the present invention;

FIG. 3 is a flowchart showing processing procedures in a preferred embodiment of the present invention;

FIG. 4 is a flowchart showing processing procedures in a preferred embodiment of the present invention;

FIG. 5 is a flowchart showing processing procedures in the preferred embodiment of the present invention;

FIG. 6 is a flowchart showing processing procedures in a preferred embodiment of the present invention; and

FIG. 7 is a schematic diagram showing the use of the preferred embodiment of the present invention.

### DETAILED DESCRIPTION OF THE PREFERRED EMBODIMENTS

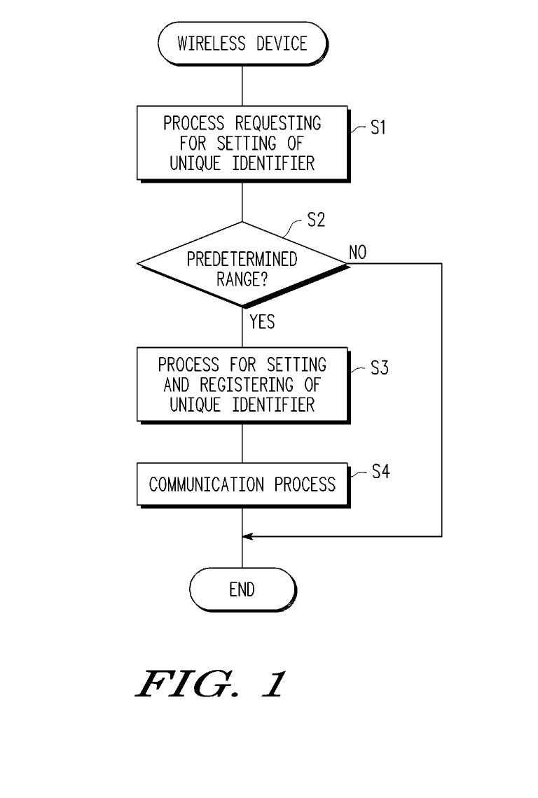

A preferred embodiment of the present invention will now be discussed with reference to FIGS. 1 to 7. In this embodiment, a wireless communication device, an individual information writing device, and an individual information setting method used when writing individual information, such as a unique identifier, for wireless communication to each wireless device will be described.

### [Setting and Registration of Unique Identifier]

A writing device writes a unique identifier, which serves as individual information, to a writing subject device. Then, the individual information writing device and the writing subject device perform wireless communication with each other. As a result, the writing device sets and registers the unique identifier to the writing subject device.

FIG. 1 is a flowchart showing this process. The writing device first performs a process for requesting the writing subject device to set the unique identifier (step S1).

Then, it is checked whether a writing condition, which is the writing device and the writing subject device being within a predetermined range, is satisfied (step S2). When the writing device and the writing subject device are within the predetermined range (YES in step S2), a process for setting and registering the unique identifier is performed (step S3). Then, a communication process is carried out to check the setting of the unique identifier to the writing subject device (step S4). If the writing device and the writing subject device are not in the predetermined range (NO in step S2), the process for setting and registering the unique identifier is not performed (step S3).

The checking of whether the writing device and the writing subject device are within the predetermined range (step S2) may be performed by the writing device. This may also be performed by the writing subject device or by both the writing device and the writing subject device.

### First Embodiment

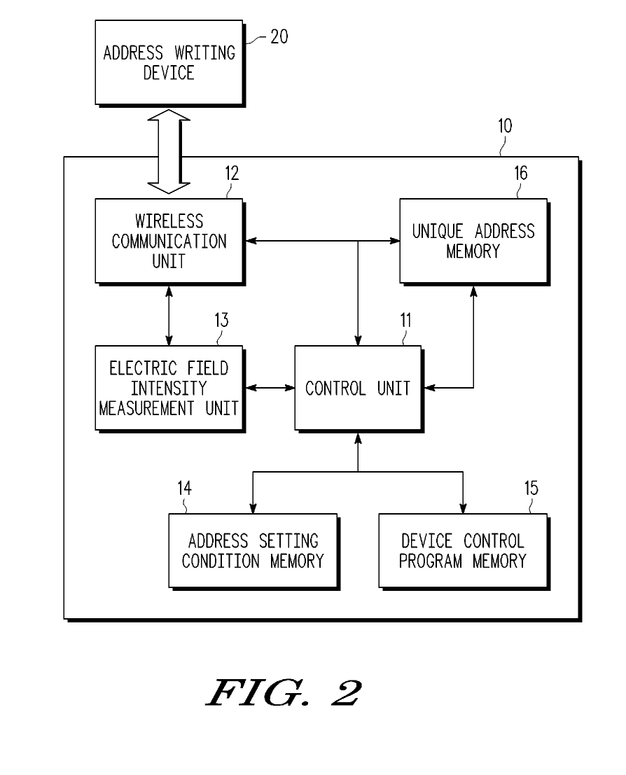

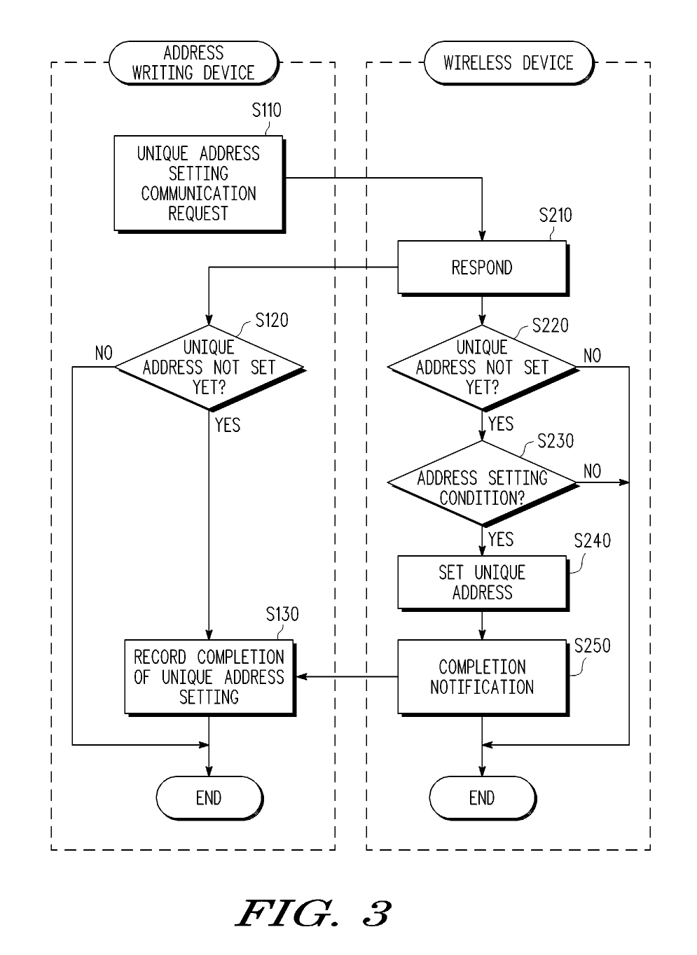

A first embodiment to which the above processing procedures are applied will now be discussed with reference to FIGS. 2 and 3. In this embodiment, a wireless communication device, an individual information writing device, and an individual information setting method employed when writing a unique address used in wireless communication to each network card (wireless device) for wireless communication will be described.

In this embodiment, as shown in FIG. 2, a wireless device 10 and an address writing device 20 are used. Here, a communication module (network card) for a wireless LAN is used as the wireless device 10. The wireless device 10, which is a wireless communication terminal and includes a wireless communication function, performs wireless communication with the address writing device 20.

The wireless device 10 includes a control unit 11 functioning as a control means, a wireless communication unit 12 functioning as a communication means, an electric field intensity measurement unit 13 functioning as a radio wave intensity measurement means, an address setting condition memory 14, a device control program memory 15, and a unique address memory 16 functioning as an individual information storage unit.

The wireless communication unit 12 performs wireless communication with an external device using the individual information. The electric field intensity measurement unit 13 obtains the electric field intensity of a signal received by the wireless communication unit 12.

The address setting condition memory 14 records a threshold value serving as a reference value for the electric field intensity and used when setting an address. The electric field intensity of a radio wave attenuates in accordance with the distance from a signal transmission source. Thus, when the electric field intensity is greater than or equal to the threshold value, it can be recognized that the signal transmission source of the radio wave is within a predetermined range.

Program data for operating the control unit 11 is recorded in the device control program memory 15.

A unique address used when the wireless device 10 performs wireless communication is recorded in the unique address memory 16. A writable and erasable non-volatile memory is used as the unique address memory 16. A common provisional address (provisional individual information) is written as an initial value to the unique address memory 16. The provisional address is used when initially performing wireless communication.

The control unit 11 reads a unique identifier writing program recorded on the device control program memory 15 to control the wireless communication unit 12 and the electric field intensity measurement unit 13.

The address writing device 20 is a computer system for performing various types of data processing relating to the writing of the unique identifier to the wireless device 10. The address writing device 20 includes a CPU, RAM, and ROM (none shown) to perform processes such as the setting and checking of the unique individual information and the writing of the unique individual information. The address writing device 20 executes a management program to function as a means for setting and checking unique individual information and as a means for writing unique individual information.

In the above system, the procedures of the processes performed by the address writing device 20 and the wireless device 10 will now be discussed with reference to FIG. 3.

First, the address writing device 20 transmits a unique address setting communication request (step S110). More specifically, the address writing device 20 transmits a command requesting for the unique address to be set. The address writing device 20 also transmits request data including the unique address (MAC address) allocated to the wireless device 10.

The wireless device 10 then responds to the unique address setting communication request (step S210). In this case, the wireless communication unit 12 responds by using the address written to the unique address memory 16. When the unique address has not been set yet, the wireless device 10 responds with the provisional address.

The address writing device 20 checks whether the unique address is set (step S120). More specifically, the address writing device 20 stores the provisional address (provisional individual information), which is predetermined. Thus, the address writing device 20 compares the address contained in the received response with the stored provisional address to check whether the unique address has been set. If the address differs from the provisional address, this will indicate that the unique address has been set. In such a case (NO in step S120), the address writing device 20 ends the processing. If the address in the received response is the provisional address (YES in step S120), the address writing device 20 waits until the wireless device 10 completes the writing process.

The wireless device 10 receiving the unique address setting communication request checks whether the unique address has been set (step S220). More specifically, the control unit 11 stores the provisional address (provisional individual information), which is predetermined. Thus, the control unit 11 compares the address written to the unique address memory 16 with the stored provisional address to check whether the unique address has been set.

If a unique address, which differs from the provisional address, is set in the unique address memory 16 (NO in step S220), the wireless device 10 ends the unique address setting process.

If the provisional address is set in the unique address memory 16 (YES in step S220), the control unit 11 of the wireless device 10 checks whether the signal intensity of the unique address setting communication request received from the address writing device 20 is within a predetermined range (step S230). More specifically, the control unit 11 uses the electric field intensity measurement unit 13 to measure the signal intensity of the unique address setting communication request received from the address writing device 20. Then, the control unit 11 acquires the threshold value of the electric field intensity from the address setting condition memory 14. If the signal intensity of the unique address setting communication request is smaller than the threshold value and not within the predetermined range, that is, the address setting condition is not satisfied (NO in step S230), the wireless device terminates processing.

If the signal intensity is greater than the threshold value and the address setting condition is thus satisfied (YES in step S230), the wireless device 10 performs a process for setting the unique address (step S240). More specifically, the control unit 11 of the wireless device 10 writes the unique address (MAC address), which is included in the unique address setting communication request, to the unique address memory 16.

Then, the wireless device 10 transmits a completion notification of the unique address setting to the address writing device 20 (step S250). More specifically, the control unit 11 of the wireless device 10 transmits the completion notification using the MAC address written to the unique address memory 16. The address writing device 20, which is in a waiting state, then records completion of the unique address setting process.

This embodiment has the advantages described below.

In the first embodiment, a predetermined common provisional address is set for the unique address memory 16. Thus, wireless communication using the provisional address may be performed when other wireless devices are not located nearby. Accordingly, an address unique to a wireless device may be set using the wireless function of the wireless device. Further, since a common provisional address is used, acknowledgment of the provisional address would enable determination of whether a unique address has been set in the wireless device.

In the first embodiment, the wireless device 10 that receives the unique address setting communication request checks whether or not the unique address has been set (step S220). Further, the control unit 11 of the wireless device 10 checks whether the signal intensity of the unique address setting communication request received from the address writing device 20 satisfies the address setting condition (step S230). If the condition is satisfied, the control unit 11 records the address included in the unique address setting communication request to the unique address memory 16. Thus, an external interface connection, such as when recording an address by connecting a cable, is not necessary, and efficient writing of a unique identifier through a wireless means in enabled. Further, since there is no need for an external interface to connect a cable, mechanical damages are prevented. Additionally, when a unique address differing from the provisional address has already been set (NO in step S220), the wireless device 10 ends the process for setting the unique address. This prevents unnecessary writing of the unique address.

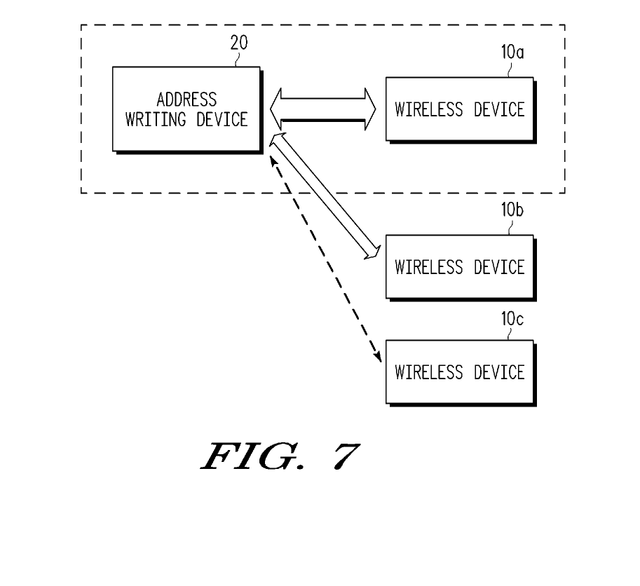

In the first embodiment, when the provisional address is set in the unique address memory 16 (YES in step S220), the control unit 11 of the wireless device 10 checks whether the signal intensity of the unique address setting communication request received from the address writing device is within the predetermined range (step S230). If the signal intensity is greater than the threshold value and the address setting condition is thus satisfied (YES in step S230), the wireless device 10 performs a process for setting the unique address (step S240). When address setting is performed through wire connections, the device subjected to address setting may be specified by locating the device connected to a cable. However, when address setting is performed in a wireless manner, if there are a plurality of devices within a communicable distance as shown in the state of FIG. 7, in addition to wireless device 10a, which is the writing subject, wireless devices 10b and 10c may also respond to the request. In such a case, when using a common provisional address, interference between the devices occurs and hinders the recognition of each terminal. In such a case, the other wireless devices 10b and 10c must either be moved out of the communication range or be deactivated so that there is only one device using the provisional address within the communicable distance. In the present invention, the unique address is not written if the address setting condition is not satisfied. Thus, the setting of the unique address is efficiently performed.

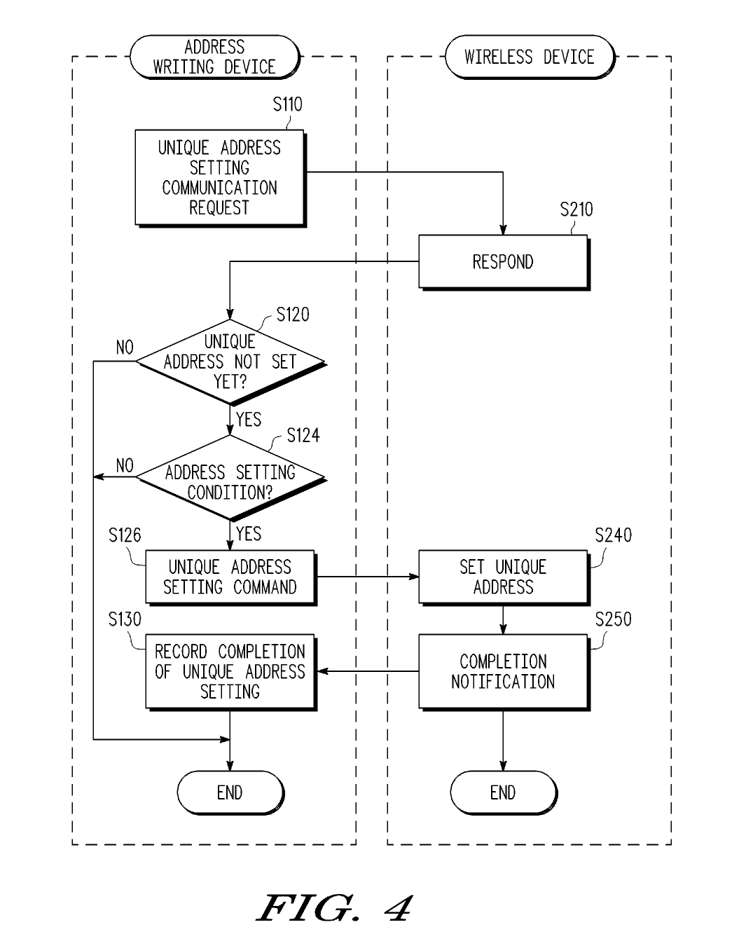

A second embodiment of the present invention will now be discussed with reference to FIG. 4. In the first embodiment, the wireless device 10 checks the writing condition of whether the writing device and the writing subject device are within a predetermined range (S2). The control unit 11 of the wireless device 10 then checks whether the signal intensity of the unique address setting communication request received from the address writing device 20 is within the predetermined range. When the signal intensity is greater than the threshold value and the address setting condition is thus satisfied, the wireless device 10 performs the process for setting the unique address (step S240). The second embodiment differs from the first embodiment in that the address writing device 20 checks the writing condition of whether the writing device and the writing subject device are within a predetermined range (S2). Parts differing from the first embodiment will now be described.

The address writing device 20 includes an electric field intensity measurement unit 13 and an address setting condition memory 14. The unique address setting communication request transmitted in step S110 does not include a fixed address.

As shown in FIG. 4, it is determined whether the intensity of a signal received from the wireless device 10 is within a predetermined range (step S124). More specifically, the address writing device 20 measures the signal intensity of a response from the wireless device 10.

If the signal intensity is greater than the threshold value and is within a predetermined range thereby satisfying the address setting condition (YES in step S124), the address writing device 20 transmits a unique address setting command, which includes a unique address and a registration command (step S126). The wireless device 10, which receives the unique address setting command, performs a process for setting the unique address (step S240).

If the signal intensity is smaller than the threshold value and not within the predetermined range, or does not satisfy the address setting condition (NO in step S124), the unique address setting command is not transmitted, and the process for setting the unique address ends.

In addition to the advantages of the first embodiment, the second embodiment has the following advantage.

The address writing device 20 checks whether the writing device and the writing subject device are within a predetermined range. Thus, the unique address may be set without arranging the electric field intensity measurement unit 13 or the address setting condition memory 14 in the wireless device 10.

It should be apparent to those skilled in the art that the present invention may be embodied in many other specific forms without departing from the spirit or scope of the invention. Particularly, it should be understood that the present invention may be embodied in the following forms.

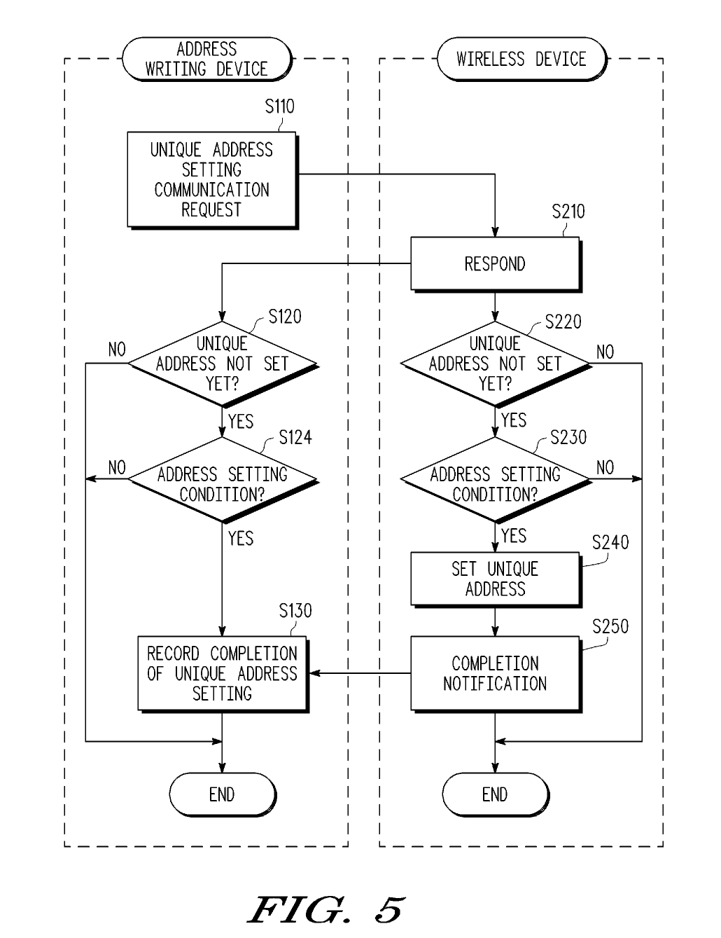

In the first embodiment, the wireless device 10 checks the writing condition. More specifically, when the address of the received response is the provisional address (YES in step S120), the address writing device 20 waits for the wireless device 10 to perform the writing process. In addition, the address writing device 20 may also check whether the wireless device 10 is located within the predetermined range. More specifically, the address writing device 20 may also include the electric field intensity measurement unit 13 and the address setting condition memory 14. In this case, as shown in FIG. 5, the address writing device 20 checks whether or not the intensity of the signal received from the wireless device 10 is within a predetermined range (step S124). The address writing device 20 measures the signal intensity of the response from the wireless device 10. If the signal intensity is smaller than the threshold value and not within the predetermined range, or does not satisfy the address setting condition (NO in step S124), the process for setting the unique address ends. This ensures that proper processing is performed.

In the first embodiment, the address writing device 20 checks whether or not the unique address is set (step S120). If at least either one of the address writing device 20 and the wireless device 10 has performed the process for checking the unique address setting condition, step S120 performed by the address writing device 20 may be eliminated. This enables efficient processing.

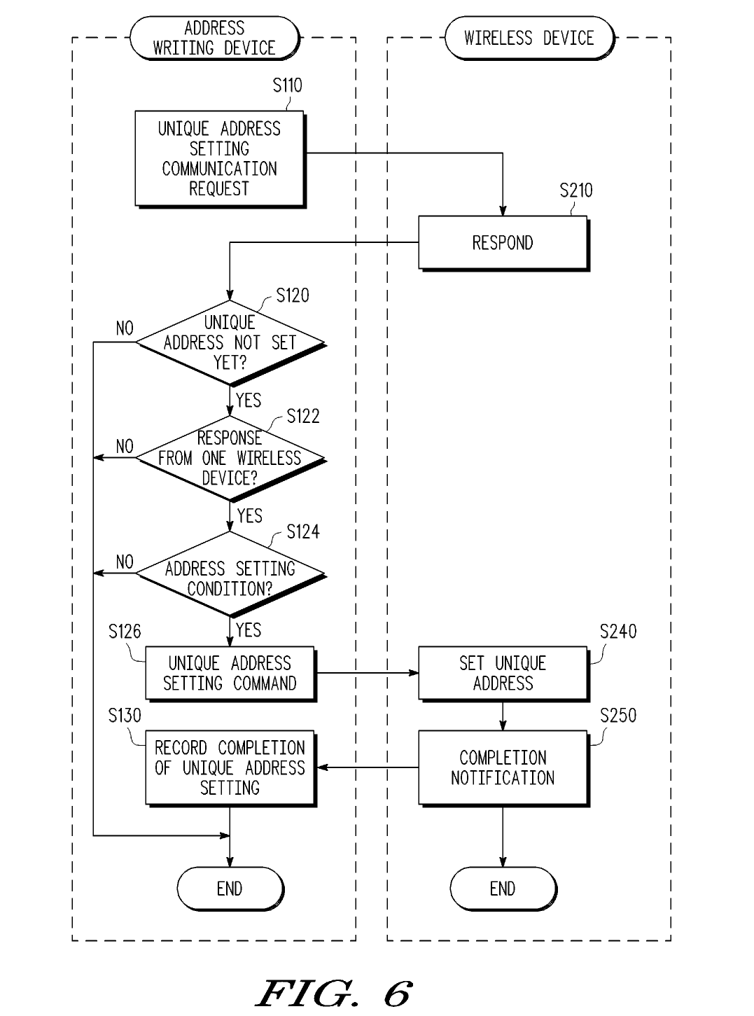

In the second embodiment, the address writing device 20 checks whether the intensity of the signal received from the wireless device 10 is included in the predetermined range (step S124). If the signal intensity is greater than the threshold value and is within the predetermined range thereby satisfying the address setting condition (YES in step S124), a unique address setting command, which includes a unique address and a registration command, is transmitted (step S126). In addition, as shown in FIG. 6, the address writing device 20 may check whether there is only one response, which indicates that the unique address has not been set yet, from a wireless device 10 (step S122). When there are responses from a plurality of devices (NO in step S122), the process for setting the unique address is terminated. This ensures that processing is performed in a proper manner.

In the first and second embodiments, processes for setting the MAC address for a network card are performed. However, the writing subject device is not limited to a network card. Individual information may be set to identify any terminal or device used for wireless communication. For example, the present invention may be applied when registering a remote controller in a control subject device (e.g., a household appliance such as a television or an air conditioner) through wireless communication. For example, the remote controller and the control subject device may each store a unique identifier. The remote controller is held within a predetermined distance (e.g., within ten centimeters) from the control subject device and a predetermined registration button is then pressed. The electric field intensity of a signal is also measured in this case by the remote controller or the control subject device. When the signal intensity is greater than the threshold value and is within a predetermined range thereby satisfying the address setting condition, the unique identifier of the remote controller and a control address are stored in the control subject device. This sets the individual information in an efficient and ensured manner.

In the first and second embodiments, the MAC address is written as unique individual information. However, the individual information is not limited in such a manner and any unique identifier or program may be applied to a wireless device.

The present examples and embodiments are to be considered as illustrative and not restrictive, and the invention is not to be limited to the details given herein, but may be modified within the scope and equivalence of the appended claims.

1. A wireless communication device, comprising:
an individual information storage unit for storing individual information used for wireless communication;
a wireless communication unit coupled to the individual information storage unit, for performing wireless communication using the individual information stored in the individual information storage unit;
a radio wave intensity measuring unit coupled to the wireless communication unit for measuring electric field intensity of a wireless radio wave received from a communication partner; and
a control unit for receiving the individual information, wherein the control unit checks whether unique individual information used for wireless communication with a communication partner is set in the individual information storage unit and performs a process for writing the individual information acquired from the communication partner to the individual information storage unit when the electric field intensity of the wireless radio wave from the communication partner measured by the radio wave intensity measurement unit is greater than or equal to a reference value.

2. The wireless communication device according to claim 1, wherein:
the individual information storage unit records predetermined provisional individual information before the unique individual information used for wireless communication is set;
the radio wave intensity measurement unit measures the electric field intensity when wireless communication is performed with the predetermined provisional individual information; and
the control unit performs a process for writing the unique individual information, which is acquired when wireless communication with the communication partner is performed, to the individual information storage unit.

3. (canceled)

4. (canceled)

5. A method for setting individual information of a wireless device using:
an individual information storage unit for storing individual information used for wireless communication;
a communication unit for performing wireless communication using the individual information stored in the individual information storage unit;
a radio wave intensity measuring unit for measuring electric field intensity of a wireless signal; and
an individual information writing device for performing a process for writing the individual information to the individual information storage unit, the method comprising:
transmitting a wireless signal related to an individual information setting request including unique individual information to a wireless device with the individual information writing device;
locating individual information included in a response from the wireless device with the individual information writing device;
comparing the located individual information received in the response from the wireless device and predetermined provisional individual information with the individual information writing device;
measuring the electric field intensity of a wireless signal of the response with the radio wave intensity measuring unit; and
performing a process for writing unique individual information to the individual information storage unit when the individual information included in the response is identical to the provisional individual information and the electric field intensity is greater than or equal to a reference value.

6. The wireless communication device according to claim 2, further comprising:
an address setting condition memory coupled to the control unit for storing the reference value.

7. The wireless communication device according to claim 2, further comprising:
a device control program memory coupled to the control unit for storing program instructions executed by the control unit.

8. The wireless communication device according to claim 2, wherein the individual information storage unit comprises an erasable non-volatile memory.
